(19) United States
(12) Patent Application Publication
(10) Pub. No.: US 2014/0339314 A1
(43) Pub. Date: Nov. 20, 2014

(54) RFID TAG AND PACKAGE USING SAME

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: ZONG-YUAN SUN, New Taipei (TW); DA-HUA XIAO, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/040,759

(22) Filed: Sep. 30, 2013

(30) Foreign Application Priority Data
May 17, 2013 (CN) 2013202707605

(51) Int. Cl. G06K 19/077

(52) U.S. Cl. CPC G06K 19/07749
USPC 235/492

(57) ABSTRACT

A radio frequency identification (RFID) tag includes a shell and a tag. The tag includes a base board, an antenna, and an RFID microchip. The RFID microchip is electronically connected to the antenna. The antenna and the RFID microchip are mounted on the base board, and the base board is received in the shell.

### BACKGROUND

1. Technical Field

The disclosure generally relates to radio frequency identification (RFID) tags, and particularly to a tube-shaped enclosure for an RFID tag and a package using the RFID tag.

2. Description of the Related Art

Tracking and verification of articles has greatly evolved in transportation business through the use of RFID tags. When articles are packed in a package (e.g., a box), an RFID tag is attached to an external surface of the package. However, the RFID tags are usually made of thin paper, so they may be easily damaged during handling.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present exemplary embodiments.

FIG. 1 is a schematic, exploded view of an exemplary embodiment of a tube-shaped radio frequency identification (RFID) tag.

FIG. 2 is a schematic, assembled view of the tube-shaped RFID tag of FIG. 1.

FIG. 3 is a schematic view of an exemplary embodiment of a package using the tube-shaped RFID tag of FIG. 1.

### DETAILED DESCRIPTION

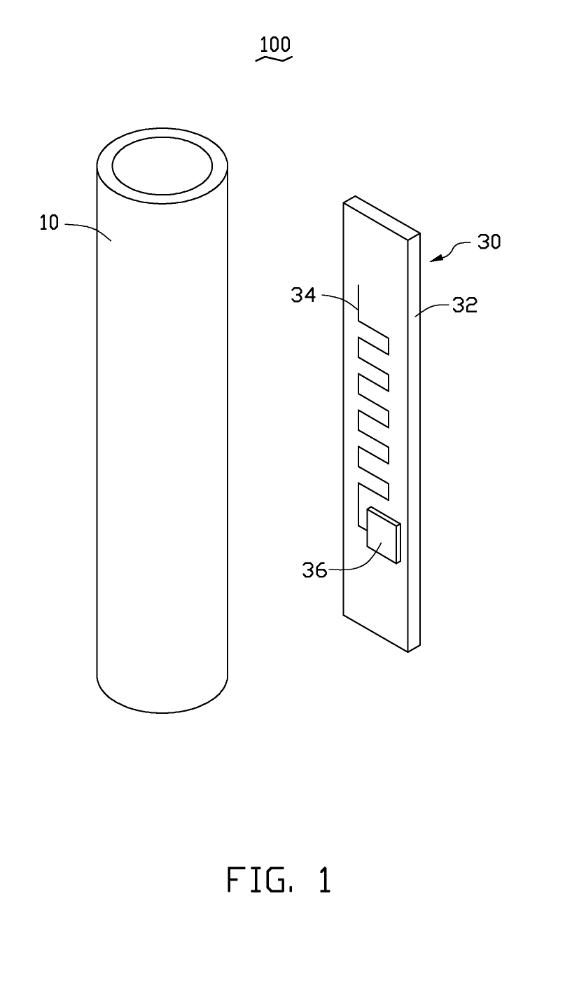

FIG. 1 is a schematic, exploded view of an exemplary embodiment of a tube-shaped radio frequency identification (RFID) tag 100. The RFID tag 100 tracks articles during packing, transportation, and verification processes of the articles. The articles can be of any size and have any value, such as clothes or computers, for example.

The RFID tag 100 includes a shell 10 and a tag 30. The tag 30 is received in the shell 10.

The shell 10 is substantially tube-shaped and is made of plastic. In this exemplary embodiment, the shell 10 is made of plastic and has an inner diameter of about 1.5 millimeters (mm). In other embodiments, the shell 10 can be made of other suitable materials.

The tag 30 is a passive electronic component that works at frequencies of about 902-928 MHz. In this exemplary embodiment, a reading/writing radius of the tag 30 is about 10 meters. The tag 30 includes a base board 32, an antenna 34, and an RFID microchip 36. The base board 32 can be a printed circuit board (PCB). In this exemplary embodiment, the base board 32 is substantially rectangular, and has a width of about 1 mm. The antenna 34 and the RFID microchip 36 are mounted on the base board 32, and one end of the antenna 34 is connected to the RFID microchip 36. The RFID microchip 36 stores predetermined identification information, such as a name, a production date, a type, and other related information of the articles. The antenna 34 has a predetermined power sensitivity and communicates with an RFID reader (not shown). If a transmitting power of the RFID reader is greater than the predetermined power sensitivity, the antenna 34 is activated to send the predetermined identification information to the RFID reader. Thus, the RFID reader can track the articles through the RFID tag 100.

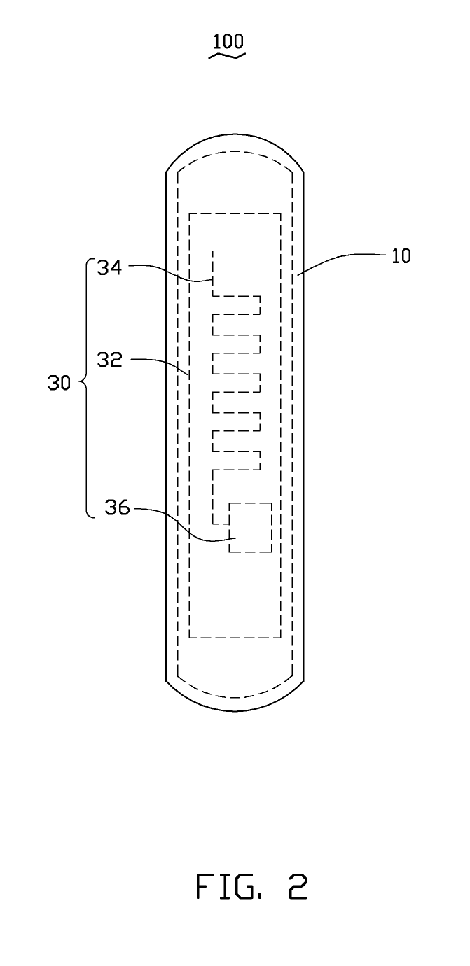

In assembly, referring to FIG. 2, the tag 30 is received in the shell 10. Since the base board 32 is substantially rectangular and the shell 10 is substantially tube-shaped, the base board 32 is frictionally held by an inner surface of the shell 10, so that the tag 30 does not slide in the shell 10. Two opposite ends of the shell 10 are sealed by ultrasonic bonding or other known processes.

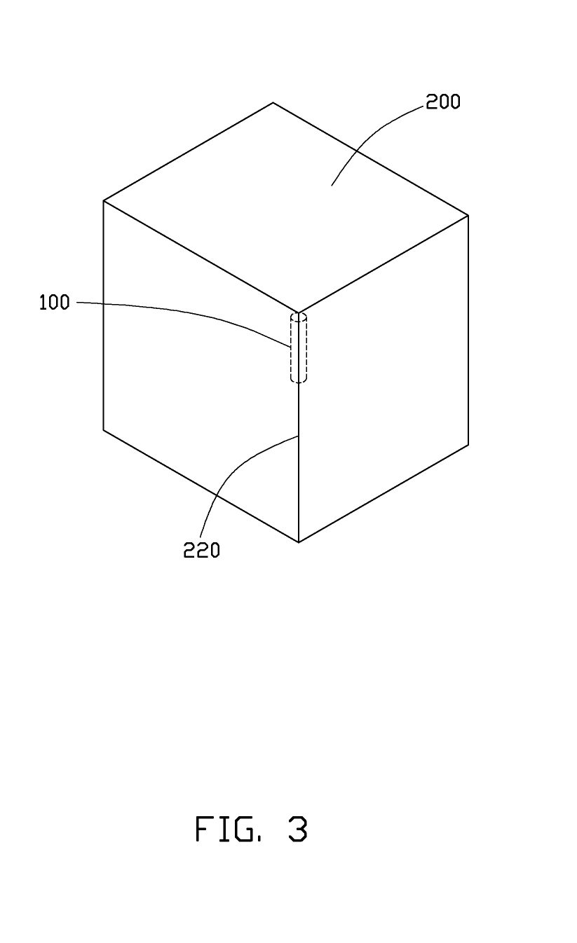

FIG. 3 is a schematic view of a package 200 using the RFID tag 100. The package 200 can be a box or any other suitable storage container to accommodate an article. The package 200 includes a corner edge 220, and the RFID tag 100 is fixed in the corner edge 220.

In other embodiments, the RFID tag 100 can be fixed to other suitable locations of the package 200. Since the RFID tag 100 is assembled in the package 200, it will not be damaged during handling.

In summary, the tag 30 is received in the shell 10, so that the tag 30 is protected from damage during handling. The RFID tag 100 has a high stability, and is easily assembled in the package 200. In addition, the antenna 34 and the RFID microchip 36 are mounted on the base board 32. Thus, design and manufacture of the tag 30 is simplified and a cost is reduced.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of the exemplary disclosure to the full extent indicated by the broad general meaning of the terms in which the appended claims are expressed.

What is claimed is:

1. A radio frequency identification (RFID) tag, comprising:
a shell; and
a tag comprising a base board, an antenna, and an RFID microchip electronically connected to the antenna, the antenna and the RFID microchip mounted on the base board, and the base board received in the shell.

2. The RFID tag as claimed in claim 1, wherein the shell is tube-shaped.

3. The RFID tag as claimed in claim 2, wherein an inner diameter of the shell is about 1.5 mm.

4. The RFID tag as claimed in claim 1, wherein the shell is made of plastic.

5. The RFID tag as claimed in claim 1, wherein the base board is a printed circuit board (PCB).

6. The RFID tag as claimed in claim 1, wherein the base board is rectangular, and has a width of about 1 mm.

7. The RFID tag as claimed in claim 1, wherein the tag is a passive electronic component.

8. A package assembling a radio frequency identification (RFID) tag, the RFID tag comprising:
a shell; and
a tag comprising a base board, an antenna, and an RFID microchip electronically connected to the antenna, the antenna and the RFID microchip mounted on the base board, and the base board received in the shell.

9. The package as claimed in claim 8, wherein the package includes a corner edge, and the RFID tag is fixed in the corner edge.

10. The package as claimed in claim 8, wherein the shell is tube-shaped, and an inner diameter of the shell is about 1.5 mm.

11. The package as claimed in claim 8, wherein the base board is rectangular, and has a width of about 1 mm.
